(19) United States
(12) Patent Application Publication
(10) Pub. No.: US 2024/0402390 A1
(43) Pub. Date: Dec. 5, 2024

(54) Model-Based Method of Estimating Optical Electro-Chemical Cell State Via Electrical Input

(71) Applicant: Apple Inc., Cupertino, CA (US)

(72) Inventors: Youngbae Son, San Jose, CA (US); Sean E. Doris, San Francisco, CA (US); Shengchang Cai, Santa Clara, CA (US); Zachary M. Beiley, Oakland, CA (US); Johan L. Piper, Cupertino, CA (US)

(21) Appl. No.: 18/678,594

(22) Filed: May 30, 2024

Related U.S. Application Data
(60) Provisional application No. 63/505,788, filed on Jun. 2, 2023.

(51) Int. Cl. G02B 1/10; G06T 19/00

(52) U.S. Cl. CPC G02B 1/10; G06T 19/006

(57) ABSTRACT

An electronic device includes a light-transmissive tint layer implemented on a light-transmissive viewing surface, on which a display panel is used to display augmented reality image content overlaid on background image content. A tint driver is used to apply electrical inputs to the light-transmissive tint layer to change optical properties of the light-transmissive tint layer. The temperature of the light-transmissive tint layer may be inferred from an electrical current applied to the light-transmissive tint layer. Dynamic values of the optical properties of the light-transmissive tint layer are predicted based on the electrical inputs and the temperature of the light-transmissive tint layer. The dynamic values of the optical properties are used to generate real-time compensated image data for the augmented reality image content.

### CROSS-REFERENCE TO RELATED APPLICATIONS

This application claims priority to U.S. Provisional Application No. 63/505,788, filed Jun. 2, 2023, which is incorporated by reference herein in its entirety.

### SUMMARY

This disclosure relates generally to estimating optical electro-chemical cell state via electrical input and, more particularly, to predicting optical properties (e.g., light absorption, light transmission, light reflection) of electro-chemical materials.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Electronic displays are found in numerous electronic devices, such as mobile phones, computers, televisions, automobile dashboards, and augmented reality or virtual reality or mixed reality headsets or glasses, to name just a few. Electronic displays control the amount of light emitted from their display pixels based on corresponding image data to produce images. Processing circuitry of the electronic device may generate or retrieve the image data that may be used to program the display pixels of the electronic display to display an image. In some scenarios, the display panel may display augmented reality (e.g., virtual) image content overlaid on background (e.g., real) image content, thereby providing an augmented reality (AR) experience. For example, the display panel may be used to actively display (e.g., reproduce) background image content by controlling light emission from the display pixels based at least in part on corresponding image data generated by an image sensor (e.g., a camera). In some scenarios, the display panel may be implemented on a light-transmissive viewing surface, such as a lens of a wearable (e.g., headset, glasses) electronic device, a windshield of an automotive vehicle, and/or the like. The light-transmissive viewing surface may enable light to pass through, thereby enabling a user (e.g., wearer, driver, rider, or operator) to visually perceive background image content. Thus, the display panel may provide an augmented reality experience by displaying augmented reality image content anchored to one or more specific locations in background image content without actively displaying (e.g., reproducing) the background image content.

In some instances, perception of augmented reality image content may be dependent on optical characteristics, such as color and/or brightness, of background image content on which the augmented reality image content is overlaid (e.g., displayed and/or presented). For example, displaying augmented reality image content overlaid on brighter (e.g., higher luma value) background image content may reduce perceived contrast in the augmented reality image content, thereby resulting in the augmented reality image content appearing washed out compared to displaying the augmented reality image content overlaid on darker (e.g., lower luma value) background image content. Moreover, a light-transmissive tint layer (e.g., electro-chemical cell) may be laid (e.g., coated or attached) on the display panel implemented on the light-transmissive viewing surface to improve the perceived image quality of the background image content. For example, the transmittance of the light-transmissive tint layer may be changed to adjust the amount of light passing through the light-transmissive tint layer so that to adjust the color and/or brightness of the background image content displayed on the display panel implemented on the light-transmissive viewing surface. To improve the augmented reality experience, the augmented reality image content may be adaptively adjusted and compensated based at least in part on expected optical (e.g., visual) characteristics of background image content on which the augmented reality image content is to be overlaid.

To determine the expected optical characteristics of background image content, the electronic device may include sensors to monitor environmental parameters (e.g., ambient light, temperature) of the background image content or the electro-chemical cell material. For example, the sensors may include one or more ambient light sensors to determine an ambient lighting metric indicative of an average brightness level (e.g., luma value) of background light. The sensors may also include one or more temperature sensors to determine the temperature of the environment (e.g., the temperature on or around the light-transmissive tint layer) of the background image content. However, it may be difficult to implement sensors to detect the transmittance of the light-transmissive tint layer, which is associated with the temperature of the light-transmissive tint layer. The temperature of the light-transmissive tint layer may be inferred from the current applied to the light-transmissive tint layer, and the transmittance of the light-transmissive tint layer may be predicted using the temperature of the light-transmissive tint layer and voltages and currents applied to the light-transmissive tint layer.

### BRIEF DESCRIPTION OF THE DRAWINGS

Various aspects of this disclosure may be better understood upon reading the following detailed description and upon reference to the drawings described below.

FIG. 1 is a schematic block diagram of an electronic device, in accordance with an embodiment;

FIG. 2 is a schematic diagram of a display surface of the electronic device of FIG. 1, in accordance with an embodiment;

FIG. 3 is a cross section of the display surface of FIG. 2, in accordance with an embodiment;

FIG. 4 is a schematic diagram showing an example of a light-transmissive controllable tint layer on the display surface of FIG. 1, in accordance with an embodiment;

FIG. 5 is a timing diagram for the light-transmissive controllable tint layer of FIG. 4, in accordance with an embodiment;

FIG. 6 uses timing diagrams to illustrate temperature effect of the light-transmissive controllable tint layer of FIG. 4, in accordance with an embodiment;

FIG. 7 is a comparison of display adaptation effect, in accordance with an embodiment;

FIG. 8 is a diagram illustrating relationships among temperature, voltage, current, and transmittance of the light-transmissive controllable tint layer of FIG. 4 at steady states, in accordance with an embodiment;

FIG. 9 includes timing diagrams illustrating temperature effects during over-drive period of the light-transmissive controllable tint layer of FIG. 4, in accordance with an embodiment;

FIG. 10 is a flowchart of a process to sense the temperature of the light-transmissive controllable tint layer of FIG. 4, in accordance with an embodiment; and

FIG. 11 is a flowchart of a process to control the light-transmissive controllable tint layer of FIG. 4, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As mentioned previously, a light-transmissive tint layer may be laid (e.g., coated or attached) on a transmissive display panel to adjust the amount of light passing through the tint layer and displaying on the transmissive display panel. The light-transmissive tint layer may be made of electro-chemical (EC) materials, which may reversibly change their optical properties (e.g., light absorption, light transmission, light reflection) upon electrochemical oxidation and reduction. The electro-chemical materials may be used to generate optical modulation between the dark state and the bright state of the background image content. The optical properties (e.g., light absorption, light transmission, light reflection) of the light-transmissive tint layer may be controlled by adjusting the current and voltage applied to the light-transmissive tint layer.

In addition, the augmented reality (AR) image content overlaid on the background image content may have different perceived contrast between the dark state and the bright state of the background image content. For example, displaying augmented reality image content overlaid on brighter (e.g., higher luma value) background image content may reduce perceived contrast in the augmented reality image content, thereby resulting in the augmented reality image content appearing washed out compared to displaying the augmented reality image content overlaid on darker (e.g., lower luma value) background image content. The augmented reality image content may be adaptively adjusted and compensated based at least in part on expected optical (e.g., visual) characteristics of background image content on which the augmented reality image content is to be overlaid. Accordingly, the optical properties (e.g., light absorption, light transmission, light reflection) of the tint layer may be used to enable ambient adaptation of the AR image content overlaid on the background image content.

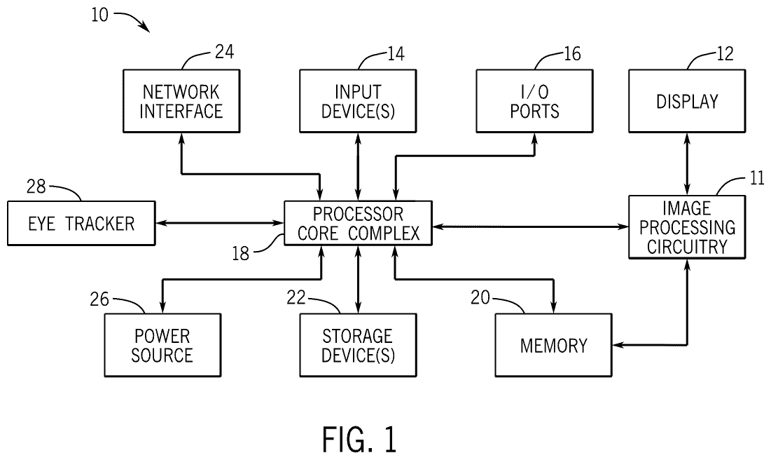

With this in mind, an electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, image processing circuitry 11, one or more input devices 14, one or more input/output (I/O) ports 16, a processor core complex 18 having one or more processor(s) or processor cores, local memory 20, a main memory storage device 22, a network interface 24, a power source 26, and eye tracker 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable gate arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, a touch sensing, or the like. The input device 14 may include touch-sensing components (e.g., touch control circuitry, touch sensing circuitry) in the electronic display 12. The touch sensing components may receive user inputs by detecting occurrence or position of an object touching the surface of the electronic display 12.

In addition to enabling user inputs, the electronic display 12 may have a display panel with an array of display pixels (e.g., with one or more display pixels) that may display different view images from different viewing angles. For example, the electronic display 12 may include a self-emissive pixel array having an array of self-emissive display pixels and a lenticular lens layer. The electronic display 12 may include any suitable circuitry (e.g., display driver circuitry) to drive the self-emissive pixels, including for example row driver and/or column drivers (e.g., display drivers). Each of the self-emissive pixels may include any suitable light emitting element, such as an LED (e.g., micro-LED or OLED). However, any other suitable type of pixel, including non-self-emissive pixels (e.g., liquid crystal as used in liquid crystal displays (LCDs), digital micromirror devices (DMD) used in DMD displays) may also be used. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling pulse emission (e.g., light emission) from its display pixels based on pixel or image data associated with corresponding image pixels (e.g., points) in the image. Before being used to display a corresponding image on the electronic display 12, the image data may be processed via the image processing circuitry 11. The image processing circuitry 11 may process the image data for display on one or more electronic displays 12. For example, the image processing circuitry 11 may include a display pipeline, memory-to-memory scaler and rotator (MSR) circuitry, warp compensation circuitry, or additional hardware or software means for processing image data. The image data may be processed by the image processing circuitry 11 to reduce or eliminate image artifacts, compensate for one or more different software or hardware related effects, and/or format the image data for display on one or more electronic displays 12. As should be appreciated, the present techniques may be implemented in standalone circuitry, software, and/or firmware, and may be considered a part of, separate from, and/or parallel with a display pipeline or MSR circuitry. The image processing circuitry 11 may be implemented in the electronic device 10, in the electronic display 12, or a combination thereof. For example, the image processing circuitry 11 may be included in the processor core complex 18, a timing controller (TCON) in the electronic display 12, or any combination thereof.

In some embodiments, pixel or image data may be generated by an image source (e.g., image data, digital code), such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display an image frame of content based on pixel or image data generated by the processor core complex 18, or the electronic display 12 may display frames based on pixel or image data received via the network interface 24, an input device, or an I/O port 16.

The eye tracker 28 may measure positions and movement of one or both eyes of someone viewing the electronic display 12 of the electronic device 10. For instance, the eye tracker 28 may include a camera that can record the movement of a viewer's eyes as the viewer looks at the electronic display 12. However, several different practices may be employed to track a viewer's eye movements. For example, different types of infrared/near infrared eye tracking techniques such as bright-pupil tracking and dark-pupil tracking may be used. In both of these types of eye tracking, infrared or near infrared light is reflected off of one or both of the eyes of the viewer to create corneal reflections. A vector between the center of the pupil of the eye and the corneal reflections may be used to determine a point on the electronic display 12 at which the viewer is looking. The processor core complex 18 may use the gaze angle(s) of the eyes of the viewer when generating image data for display on the electronic display 12.

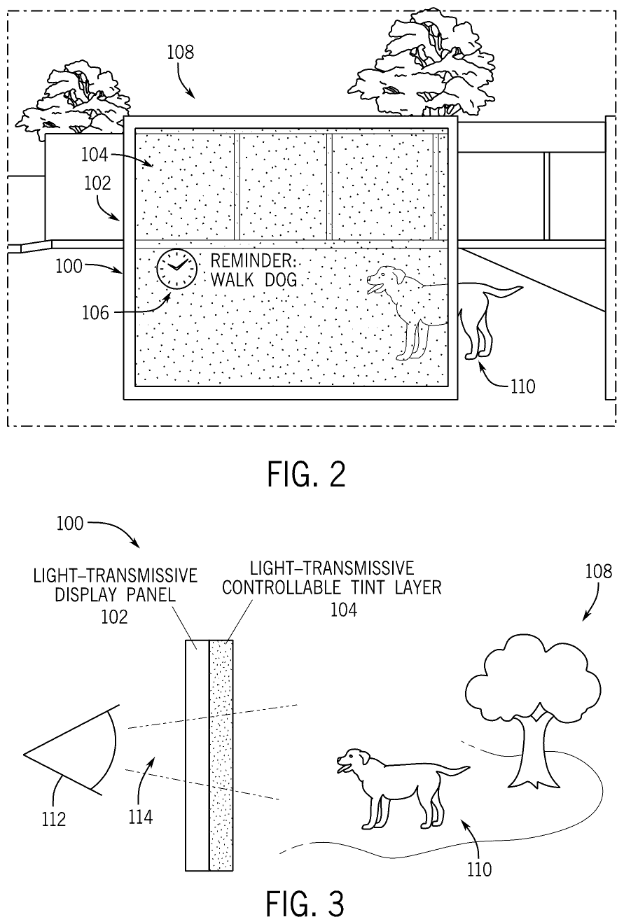

FIG. 2 is a schematic diagram that illustrates viewing augmented reality (AR) image content overlaid on background image content through a light-transmissive surface 100, which includes a light-transmissive display panel 102 and a light-transmissive controllable tint layer 104 covered on the display panel 102. As illustrated in FIG. 2, when viewing through the light-transmissive surface 100, augmented reality (AR) image content 106 may be overlaid on background image content 108. For example, the AR image content 106 may be associated with an object 110 in the background image content 108 (e.g., properties of the object 110, actions or instructions for the object 110). The AR image content 106 may be generated and displayed on the light-transmissive display panel 102 when the object 110 is viewed on the light-transmissive display panel 102.

The light-transmissive controllable tint layer 104 may be used to adjust the optical characteristics (e.g., brightness, color) of the background image content 108 viewed through the light-transmissive surface 100. The optical properties (e.g., light absorption, light transmission, light reflection) of the light-transmissive controllable tint layer 104 may be adjusted based on the environmental parameters (e.g., ambient light, temperature) of the background image content 108. For example, the transmittance of the tint layer 104 may be changed to adjust the amount of light passing through it so that to adjust the color and/or brightness of the background image content 108 viewed through the light-transmissive surface 100. For example, when the ambient light in the background image content 108 is brighter than a certain value, the optical properties (e.g., light absorption, light transmission, light reflection) of the light-transmissive controllable tint layer 104 may be adjusted to reduce the amount of light passing through it to improve the perceived image quality of the background image content 108 on the light-transmissive display panel 102.

When the color and/or brightness of the background image content 108 viewed on the light-transmissive display panel 102 is changed, the perceived contrast in the AR image content 106 may be changed. For example, when the brightness of the background image content 108 viewed on the light-transmissive display panel 102 is increased, the AR image content 106 may appear washed out on the light-transmissive display panel 102. Accordingly, the AR image content 106 may be adaptively adjusted and compensated based at least in part on expected optical (e.g., visual) characteristics of the background image content 108 viewed on the light-transmissive display panel 102.

FIG. 3 shows a cross section of the light-transmissive surface 100 of FIG. 2. The light-transmissive controllable tint layer 104 is laid (e.g., coated, attached) on a surface of the light-transmissive display panel 102. Light from the background image content 108 may pass through the light-transmissive controllable tint layer 104 and the light-transmissive display panel 102 and then enter a viewer's eye 112. When the object 110 in the background image content 108 is inside a field of view (FOV) 114 of the viewer's eye 112, the AR image content 106 may be displayed on the light-transmissive display panel 102 and overlaid on the background image content 108. The AR image content 106 may include information associated with the object 110 (e.g., properties of the object 110, actions or instructions for the object 110).

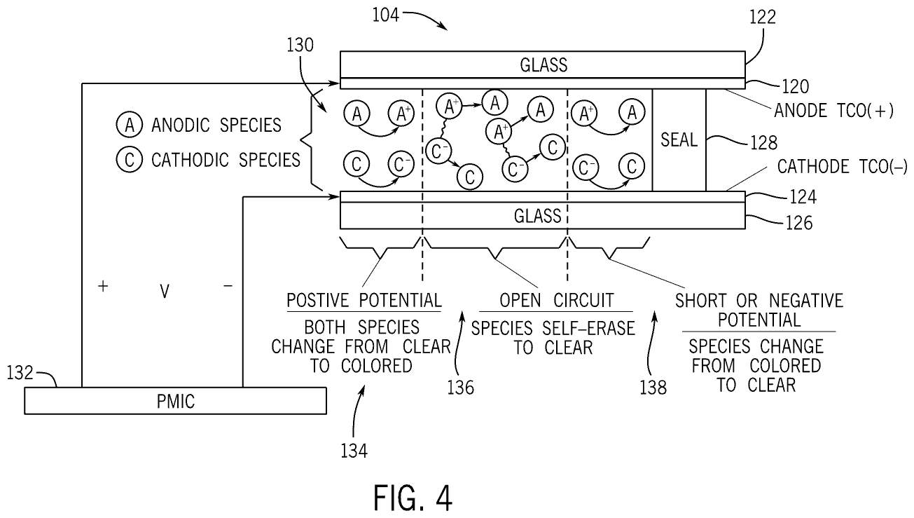

FIG. 4 is a schematic diagram showing an example of the light-transmissive controllable tint layer 104. The light-transmissive controllable tint layer 104 may be fabricated by using electro-chemical (EC) materials (e.g., EC gel) sandwiched between two optically transparent electrodes (e.g., transparent conductive oxide (TCO) coated glass). For example, an anode 120 (e.g., transparent conductive oxide (TCO)) may be coated on a layer of glass 122, and a cathode 124 (e.g., transparent conductive oxide (TCO)) may be coated on a layer of glass 126. A seal 128 may be used to seal the electro-chemical (EC) materials 130, which may include anodic (A) species and cathodic (C) species, between the anode 120 and the cathode 124.

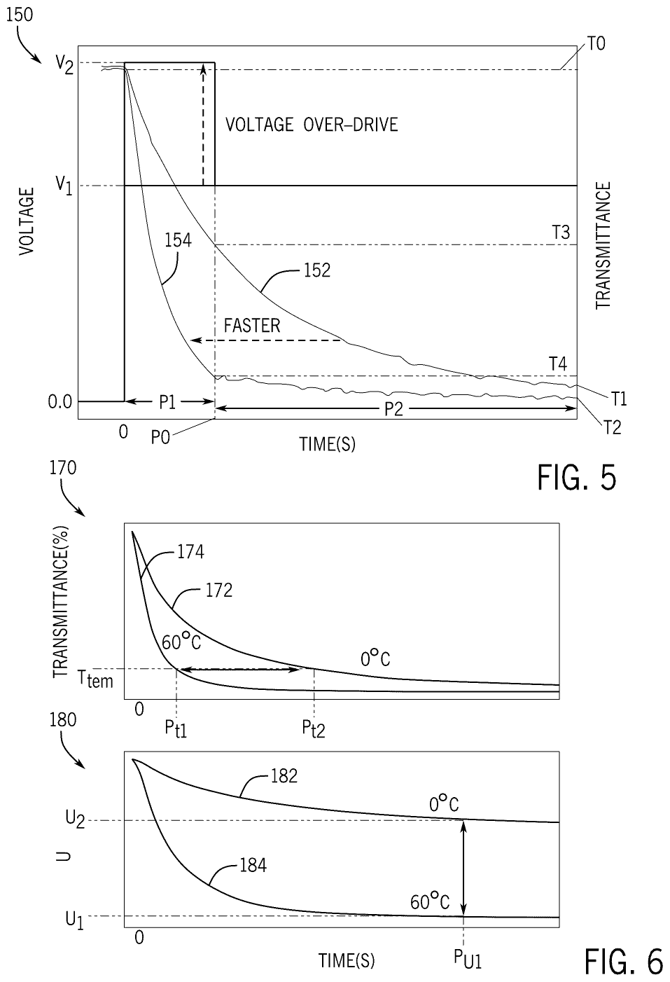

A power management integrated circuit (PMIC) 132 may be used to provide a voltage V between the anode 120 and the cathode 124. When the voltage V has a positive value, the EC materials 130 are in a reduction-oxidation (redox) state 134, in which the anodic (A) species may be oxidized and become positive ions (e.g., A⁺, A²⁺, A³⁺) and the cathodic (C) species may be reduced and become negative ions (e.g., C⁻, C²⁻, C³⁻). In the redox state 134, the EC materials 130 may change from clear to colored, resulting a reduced light transmittance of the EC materials 130 due to the increase in the light absorption. The positive ions (e.g., A⁺, A²⁺, A³⁺) and the negative ions (e.g., C⁻, C²⁻, C³⁻) in the EC materials 130 may transfer charges (e.g., via recombination process) in a self-erase process 136, so that the anodic (A) species and the cathodic (C) species are recovered from corresponding ion states. When the voltage V is turned off (e.g., open circuit), an equilibrium may be reached in the EC materials 130 via the self-erase process 136, so that the EC materials 130 may change back to clear, resulting an increased light transmittance of the EC materials 130 due to the decrease in the light absorption. When the voltage V has a negative value or the potential between the anode 120 and the cathode 124 is zero (e.g., short circuit), the EC materials 130 may be in a recovering state 138 so that the anodic (A) species and the cathodic (C) species are recovered from corresponding ion states. In the recovering state 138, the EC materials 130 may change back to clear, resulting an increased light transmittance of the EC materials 130 due to the decrease in the light absorption. Depending on the value of the voltage V, time may vary for the EC materials 130 to be recovered from corresponding ion states. Accordingly, the light transmittance of the EC materials 130 depends on the value of the voltage V, as illustrated in FIG. 5. In addition, the light transmittance of the EC materials 130 may also be affected by temperature, as illustrated in FIG. 6. It should be noted that the self-erase process 136 (e.g., via recombination process) may occur anytime when there are positive ions (e.g., A⁺, A²⁺, A³⁺) and/or negative ions (e.g., C⁻, C²⁻, C³⁻) in the EC materials 130. It should also be noted that, although in the illustrated embodiment in FIG. 6, A⁺ is used to illustrate positive ions of anodic species and C⁻ is used to illustrate negative ions of cathodic species, any other number of positive charge of anodic species (e.g., A²⁺, A³⁺) and any other number of negative charge of cathodic species (e.g., C²⁻, C³⁻) may be used in other embodiments. In addition, there may be more than one anodic species and/or more than one cathodic species in the EC materials 130. In some embodiments, the anodic species and the cathodic species may be the same.

FIG. 5 illustrates a timing diagram 150, which illustrates a relationship between the voltage V and the transmittance of the EC materials 130 with respect to time. A curve 152 illustrates a relationship between the voltage V and the transmittance of the EC materials 130 with respect to time when the voltage V has a value of V₁ in both time period of p1 and p2. A curve 154 illustrates a relationship between the voltage V and the transmittance of the EC materials 130 with respect to time when the voltage V has a value of V₂ (e.g., over-drive voltage with V₂>V₁) in the time period of p1 and the value of V₁ in the time period p2. For example, at the initial time (e.g., t=0), the voltage V may have a value of 0, and the transmittance of the EC materials 130 may have an initial value of T₀. When the voltage V has a positive value (e.g., V₁, V₂), the transmittance of the EC materials 130 may decrease with time until it reaches a target value (e.g., T1 on the curve 152, T2 on the curve 154). When the value of the voltage V increases (e.g., from V₁ to V₂), the transmittance of the EC materials 130 may decrease faster due to the reactions of the anodic (A) species and the cathodic (C) species in the redox state 134 are accelerated by the higher voltage V. For example, at time p0, the transmittance of the EC materials 130 may have a value of T3 on the curve 152 and a value of T4 on the curve 154 with T4 smaller than T3.

FIG. 6 illustrates a timing diagram 170 illustrating temperature effect on tint transmittance transition (e.g., during the transmittance transition illustrated in FIG. 5), and a timing diagram 180 illustrating temperature effect on corresponding tint chromaticity transition of the EC materials 130. In the timing diagram 170, a curve 172 illustrates changes of the transmittance of the EC materials 130 with respect to time when the temperature of the EC materials 130 has a value of 0° C., and a curve 174 illustrates changes of the transmittance of the EC materials 130 with respect to time when the temperature of the EC materials 130 has a value of 60° C. As illustrated in the timing diagram 170, the transmittance of the EC materials 130 may change faster at a higher temperature. For example, to reduce the transmittance of the EC materials 130 to a value of Tₜₑₘ, it may take a time period of pₜ₁ at temperature of 60° C. on the curve 174 and a time period of pₜ₂ at temperature of 0° C. on the curve 172 with pₜ₁ less than pₜ₂.

In the timing diagram 180, a curve 182 illustrates changes of the chromaticity of the EC materials 130 with respect to time when the temperature has a value of 0° C., and a curve 184 illustrates changes of the chromaticity of the EC materials 130 with respect to time when the temperature has a value of 60° C. As illustrated in the timing diagram 180, the chromaticity of the EC materials 130 may change faster at a higher temperature. For example, at a time p_{U1}, the chromaticity of the EC materials 130 may be reduced to a value of U₁ on the curve 184 and U₂ on the curve 182, with U₁ less than U₂.

A lookup-table-based state estimation may be used to estimate dynamic transition state of the light-transmissive controllable tint layer based on historical data. For instance, the light transmittance curve (e.g., the curve 152, the curve 154) of the EC materials 130 may be estimated by utilizing a polynomial and sigmoid function to fit the measured data (e.g., historical data) of the voltage V and the transmittance with respect to time, with temperature of the EC materials 130 (e.g., temperature of the initial state, steady state, and target state) considered. The results of the estimation may be stored in a lookup table. Values of the dynamic parameters (e.g., light transmittance) of the EC materials 130 at any time on the light transmittance curve (e.g., the curve 152, the curve 154) may be obtained by interpolation using the values stored in the lookup table.

In addition, a dynamic model may be used to determine the transmittance of the EC materials 130. For instance, the light transmittance of the EC materials 130 may have a relationship with the absorbance of the EC materials 130, which is proportional to the molar absorptivity of the anodic (A) species and the cathodic (C) species, the optical path, and the concentration of the anodic (A) species and the cathodic (C) species in the EC materials 130 (e.g., the Beer-Lambert Law). The changing rate of the absorbance of the EC materials 130 may be related to the current passing through the EC materials 130, which may be measured, and the redox induced current. The absorbance of the EC materials 130 may be estimated by using a differential equation associated with the current passing through the EC materials 130 and a relationship between the absorbance and the current passing through the EC materials 130. The measurement data of the transmittance of the EC materials 130 may be compared with the estimated value obtained by using the estimated absorbance of the EC materials 130, and the relationship between the absorbance of the EC materials 130 and the current passing through the EC materials 130 may be determined by fitting the measurement data. The light transmittance of the EC materials 130 may be calculated by using the absorbance of the EC materials 130. The dynamic model may provide values of the transmittance for any electrical inputs (e.g., voltage, current) applied to the EC materials 130.

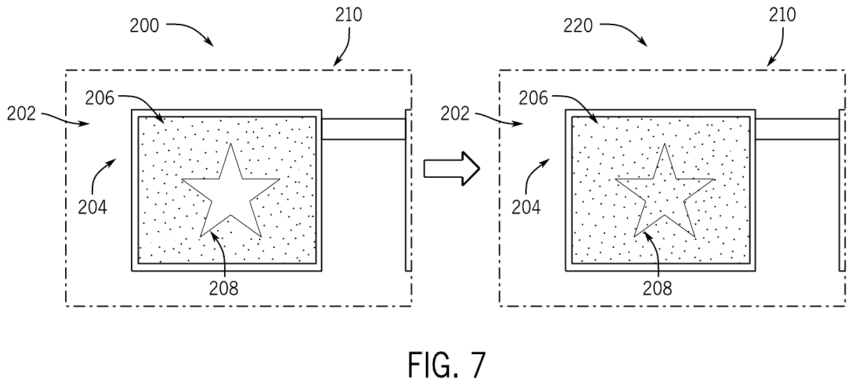

As described above, the transmittance of the light-transmissive controllable tint layer may be controlled by electrical inputs (e.g., voltage, current), which may control the brightness of the background image content viewed on the light-transmissive display panel. When the brightness of the background image content changed, the perceived contrast of the AR image content may be changed. FIG. 7 shows a diagram 200 for AR image content without display adaptation and a diagram 220 for the AR image content with display adaptation. In the diagram 200, a light-transmissive surface 202 may include a light-transmissive display panel 204 and a light-transmissive controllable tint layer 206 covered on the display panel 204. When viewing through the light-transmissive surface 202, augmented reality (AR) image content 208 may be overlaid on background image content 210. However, when the background image content 210 viewed on the light-transmissive display panel 204 changes (e.g., by changing the transmittance and/or chromaticity of the light-transmissive controllable tint layer), the AR image content 208 may be perceived with a different contrast/color on the light-transmissive display panel 204. To improve the perception of the AR image content 208, tint compensation may be applied to the AR image content 208, so that the AR image content 208 may be compensated (e.g., brightness, colors, contrast), as illustrated in the diagram 220.

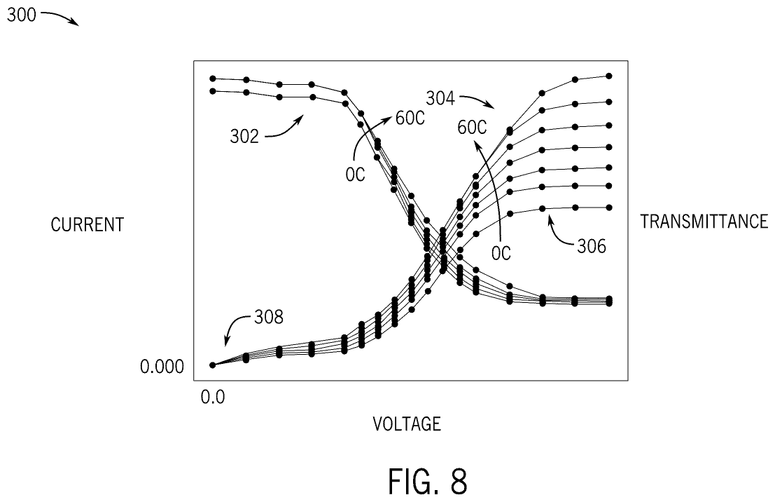

A tint driver may be used to apply electrical inputs to the light-transmissive controllable tint layer to change the optical properties (e.g., light absorption, light transmission, light reflection) of the light-transmissive controllable tint layer to improve the perceived image quality (e.g., brightness, colors) of the background image content on the display 12. The optical properties of the light-transmissive controllable tint layer may be estimated or predicted based on the applied electrical inputs, and the image data of the AR image content overlaid on the background image content may be adaptively adjusted and compensated (e.g., brightness, colors) accordingly based on the optical properties. As discussed previously with reference to FIG. 6, temperature may affect the tint transmittance transition and tint chromaticity transition of the EC materials 130. Accordingly, it may be desirable to know the temperature of the light-transmissive controllable tint layer in order to obtain more accurate optical properties of the light-transmissive controllable tint layer, thereby providing improved adjustment and compensation to the image data of the AR image content overlaid on the background image content. In some embodiments, a temperature sensor may be used to measure the temperature around the light-transmissive controllable tint layer. However, it may be difficult to directly measure the temperature of the light-transmissive controllable tint layer. In some embodiments, the temperature of the light-transmissive controllable tint layer may be inferred from the electrical current of the light-transmissive controllable tint layer, as illustrated in FIGS. 8 to 10.

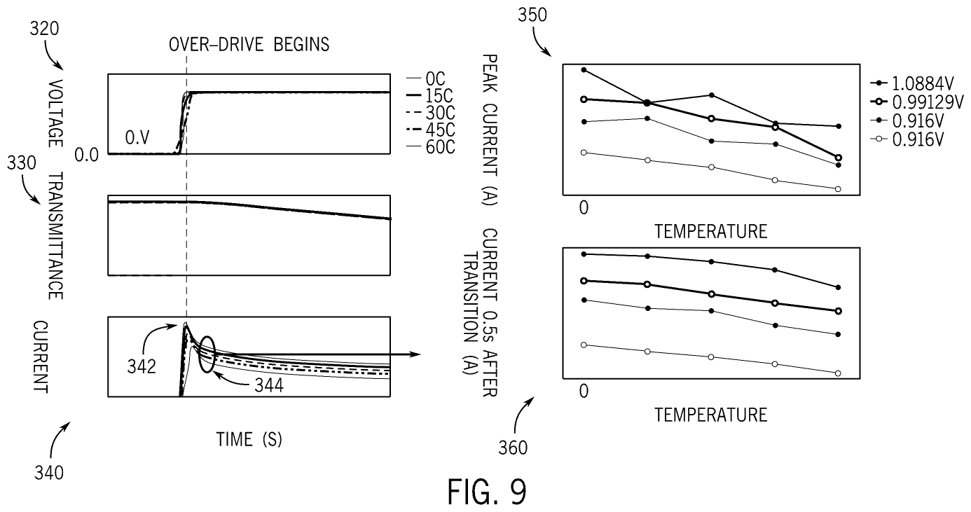

FIG. 8 is a diagram 300 illustrating relationships among temperature, voltage, current, and transmittance of the light-transmissive controllable tint layer at steady states. As illustrated in FIG. 8, a set of curves 302 illustrates changes of the transmittance of the light-transmissive controllable tint layer with respect to the voltage applied to the light-transmissive controllable tint layer at various temperatures (e.g., from 0° C. to 60° C.). A set of curves 304 illustrates changes of the current of the light-transmissive controllable tint layer with respect to the voltage applied to the light-transmissive controllable tint layer at various temperatures (e.g., from 0° C. to 60° C.). As illustrated in FIG. 8, for a non-zero voltage, the current of the light-transmissive controllable tint layer may be used to infer the temperature of the light-transmissive controllable tint layer, and a first lookup table may be used to store values of the voltage V, the current I, and the corresponding transmittance with respect to temperature for steady states in a portion 306 of the set of curves 304 when the transmittance has a steady value. However, when the voltage applied to the light-transmissive controllable tint layer has a value of zero (e.g., the tint driver is off), the current may also have a value of zero, as illustrated in a portion 308 of the set of curves 304. In the portion 308, the current of the light-transmissive controllable tint layer may not be used to infer the temperature of the light-transmissive controllable tint layer, as the current in the portion 308 has a value of zero at all temperatures. In some embodiments, when the voltage applied to the light-transmissive controllable tint layer has a value of zero (e.g., the tint driver is off), the temperature dependent transient current during over-drive period (e.g., the time period p1 in FIG. 5) may be used to infer the temperature of the light-transmissive controllable tint layer, as illustrated in FIG. 9.

FIG. 9 includes timing diagrams illustrating temperature effect during an over-drive period (e.g., the time period p1 in FIG. 5) of the light-transmissive controllable tint layer. For instance, a timing diagram 320 includes a set of curves to illustrate changes of the voltages applied to the light-transmissive controllable tint layer with respect to time during the over-drive period at various temperatures (e.g., 0° C., 15° C., 30° C., 45° C., 60° C.). A timing diagram 330 includes a set of curves to illustrate changes of the transmittance of the light-transmissive controllable tint layer with respect to time during the over-drive period at various temperatures (e.g., 0° C., 15° C., 30° C., 45° C., 60° C.). A timing diagram 340 includes a set of curves to illustrate changes of the transient current of the light-transmissive controllable tint layer with respect to time during the over-drive period at various temperatures (e.g., 0° C., 15° C., 30° C., 45° C., 60° C.). In the timing diagram 340, peaks of the transient current at various temperatures occur in a portion 342 of the curves when the over-drive begins. The transient current in the portion 342 may have non-linear relationship with respect to temperature, as illustrated in a diagram 350, and may not be used to infer the temperature of the light-transmissive controllable tint layer. In the timing diagram 340, the transient current in a portion 344 of the curves after the over-drive begins may have linear relationships with respect to temperature, as illustrated in a diagram 360, and may be used to infer the temperature of the light-transmissive controllable tint layer. The transient current and corresponding temperature in the portion 344 may be stored together with corresponding transmittance in the diagram 330 in a transient I lookup table. The diagram 350 illustrates changes of the peak transient current with respect to temperature at various voltages in the portion 342. The diagram 360 illustrates changes of the transient current with respect to temperature at various voltages in the portion 344.

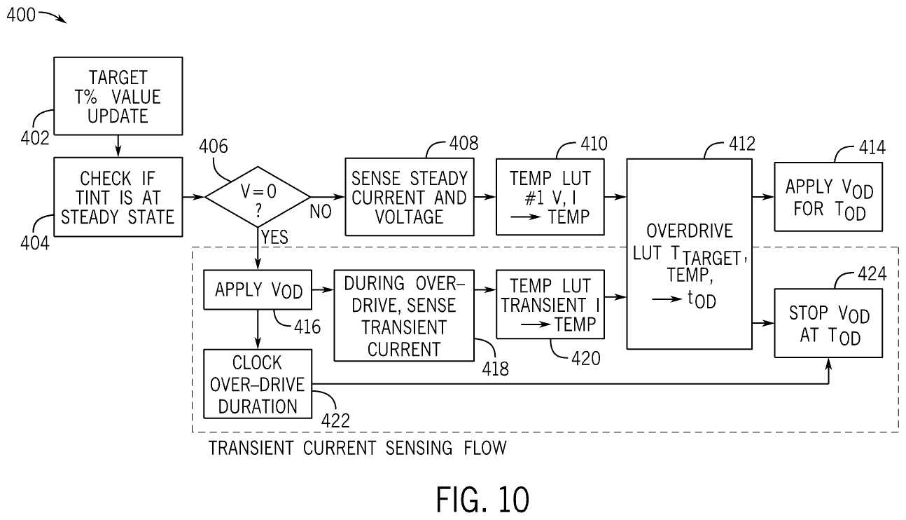

FIG. 10 shows a flowchart of a process 400 to infer the temperature of the light-transmissive controllable tint layer based on the current of the light-transmissive controllable tint layer. At block 402, a target transmittance setting (e.g., corresponding to T_{target}) may be setup or updated. At block 404, the status of the light-transmissive controllable tint layer may be checked to see whether it is at steady state (e.g., in the portion 306 or 308 of the set of curves 304 in FIG. 8). At block 406, the voltage applied by a tint driver (e.g., PMIC 132) to the light-transmissive controllable tint layer may be checked. If the voltage applied to the light-transmissive controllable tint layer has a non-zero value, at block 408, the current of the light-transmissive controllable tint layer at steady states may be used to infer the temperature of the light-transmissive controllable tint layer, as illustrated in FIG. 8. At block 410, the temperature of the light-transmissive controllable tint layer and the initial transmittance setting (e.g., corresponding to T₀) may be retrieved from the first lookup table, which is used to store values of the voltage V, the current I, and the corresponding transmittance with respect to temperature at steady states. At block 412, the temperature of the light-transmissive controllable tint layer retrieved at block 410 may be used together with the target transmittance setting (e.g., corresponding to T_{target}) and the initial transmittance setting (e.g., corresponding to T₀) to retrieve the over-drive period t_{od} from an over-drive lookup table. As illustrated in FIG. 5, applying the over-drive voltage to the light-transmissive controllable tint layer for a different over-drive period t_{od} may obtain different value of target transmittance (e.g., T3 on the curve 152, T4 on the curve 154) from the same initial transmittance (e.g., To) in a certain time period (e.g., the time period p1). In addition, as illustrated in FIG. 6, the tint transmittance transition depends on the temperature of the light-transmissive controllable tint layer. Accordingly, the over-drive period t_{od} used to obtain the target transmittance setting (e.g., corresponding to T_{target}) from the initial transmittance setting (e.g., corresponding to T₀) may depend on the temperature of the light-transmissive controllable tint layer. The over-drive lookup table may be used to store values of the over-drive period t_{od} with respect to temperature, the target transmittance setting (e.g., corresponding to T_{target}), and the initial transmittance setting (e.g., corresponding to T₀). At block 414, the tint driver may apply the over-drive voltage to the light-transmissive controllable tint layer for a time period of t_{od} to obtain the target transmittance setting (e.g., corresponding to T_{target}).

If the voltage applied to the light-transmissive controllable tint layer has a value of zero (e.g., the tint driver is off) at block 406, the current of the light-transmissive controllable tint layer may also have a value of zero and may not be used to infer the temperature of the light-transmissive controllable tint layer, as illustrated in FIG. 8. At block 416, the tint driver may apply an over-drive voltage (e.g., a predetermined voltage V_{od}) to the light-transmissive controllable tint layer, and the temperature dependent transient current during the over-drive period (e.g., the time period p1 in FIG. 5) may be used to infer the temperature of the light-transmissive controllable tint layer at block 418. At block 420, the temperature of the light-transmissive controllable tint layer and the corresponding transmittance setting may be retrieved from the transient I lookup table, which is used to store values of the transient current and the corresponding transmittance with respect to temperature during the over-drive period as described in FIG. 9. At block 412, the temperature and the corresponding transmittance setting of the light-transmissive controllable tint layer retrieved at block 420 may be used together with the target transmittance setting (e.g., corresponding to T_{target}) to retrieve the over-drive period t_{od} from the over-drive lookup table. The remaining over-drive duration may be checked at block 422. The tint driver may be controlled to stop applying the over-drive voltage (e.g., V_{od}) to the light-transmissive controllable tint layer when the over-drive period t_{od} is completed at block 424.

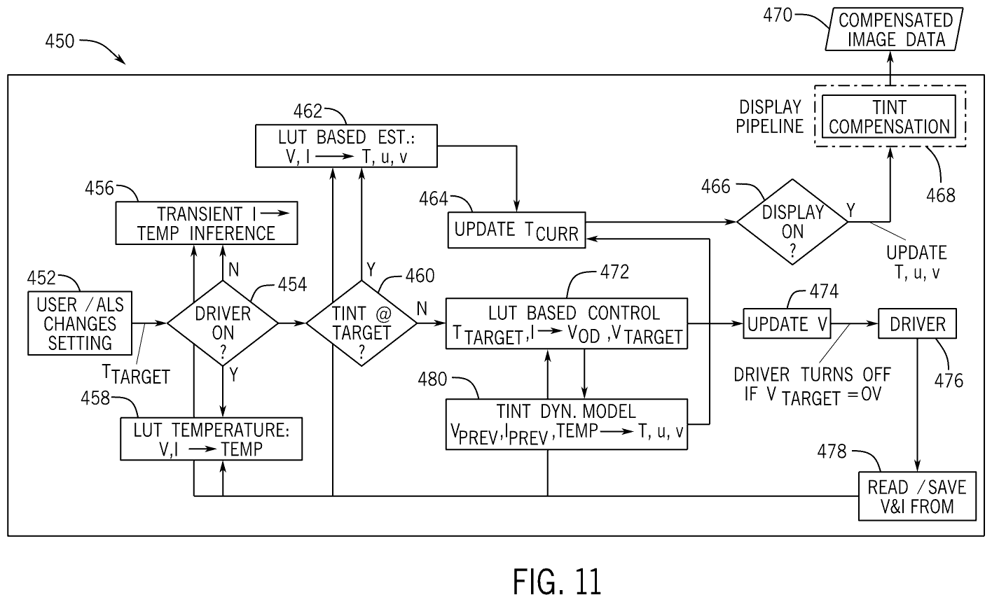

FIG. 11 shows a flowchart for a process 450 to use a tint driver (e.g., PMIC 132) to control the light-transmissive controllable tint layer and obtain compensated image data for the AR image content. In the process 450, the tint driver may apply electrical inputs to the light-transmissive controllable tint layer to change the optical properties (e.g., light absorption, light transmission, light reflection) of the light-transmissive controllable tint layer to improve the perceived image quality (e.g., brightness, colors) of the background image content on the display 12. The optical properties of the light-transmissive controllable tint layer may be estimated or predicted based on the applied electrical inputs, and the image data of the AR image content overlaid on the background image content may be adaptively adjusted and compensated (e.g., brightness, colors) accordingly based on the optical properties.

For instance, at block 452, the settings of the light-transmissive controllable tint layer may be tuned to get a target transmittance setting (e.g., corresponding to a T_{target}) either by a viewer or automatically based on measurements of ambient light sensors installed on the display 12. For example, when the ambient light of the display 12 increases, the transmittance of the light-transmissive controllable tint layer may be decreased to improve the perceived image quality of the background image content on the display 12. In some embodiment, a temperature sensor may be used to measure the temperature around the light-transmissive controllable tint layer. However, it may be difficult to directly measure the temperature of the light-transmissive controllable tint layer. In some embodiments, the temperature of the light-transmissive controllable tint layer may be inferred from the current of the light-transmissive controllable tint layer, as illustrated in FIG. 8 to FIG. 10.

After the target transmittance setting (e.g., corresponding to a T_{target}) is setup at block 452, if the tint driver is off (block 454), an over-drive voltage may be applied to the light-transmissive controllable tint layer to obtain the target transmittance setting, thereby a transient current I may be applied to the light-transmissive controllable tint layer at block 456. The temperature of the light-transmissive controllable tint layer may be inferred from the transient current I by using the transient I lookup table described in FIG. 9 and FIG. 10.

If the tint driver is on (block 454), the temperature of the light-transmissive controllable tint layer may be retrieved from the first lookup table described in FIG. 8, which includes values of the voltage V and current I with respect to temperature. Based on the voltage V and current I of the light-transmissive controllable tint layer, the temperature of the light-transmissive controllable tint layer may be inferred from the first lookup table at block 458.

If the target transmittance setting is reached (block 460), for example, determined by the viewer or automatically based on perceived background image content on the display 12, a second lookup table may be used to estimate the values of the transmittance T and chromaticity (u,v) corresponding to the temperature of the light-transmissive controllable tint layer and the applied voltage V and current I (block 462) to the light-transmissive controllable tint layer. The second lookup table may include values of the transmittance T and chromaticity (u,v) with respect to voltages V and currents I. The transmittance T and chromaticity (u,v) of the light-transmissive controllable tint layer may be updated at block 464. The updated transmittance T and chromaticity (u,v) may be sent to the display 12 (block 466) and used to generate tint compensation for the images (e.g., the AR image content 208) displayed on the display 12 in the display pipeline at block 468. The compensated image data may be generated, for example by adjusting global brightness and luminance values (e.g., gray levels) of color components of the image data (e.g., the AR image content 208), and the compensated image data may be output for display at block 470.

If the target transmittance setting is not reached (block 460), the lookup-table-based state estimation described previously may be used to determine relationships between the over-drive voltage (V_{od}), the target voltage (V_{target}), and the target transmittance T_{target} (e.g., the curve 154 in FIG. 5) based on historical data (or data from block 480) of the parameters with respect to time and temperature. A third lookup table (e.g., the over-drive lookup table in block 412 of FIG. 10) may be used, at the block 472, to obtain the over-drive period t_{od}, which may help controlling the voltage (V) applied to the light-transmissive controllable tint layer (as described in FIG. 10) based on relationships (e.g., the curve 154 in FIG. 5) between the over-drive voltage (V_{od}) (e.g., V₂ in FIG. 5) and target voltage (V_{target}) (e.g., V₁ in FIG. 5) and the target transmittance T_{target} (e.g., T₂ in FIG. 5). The third lookup table may be used to store values of the over-drive period t_{od} with respect to temperature, the target transmittance setting (e.g., corresponding to T_{target}), and the initial transmittance setting (e.g., corresponding to T₀), and may include interpolated data. The voltage applied to the light-transmissive controllable tint layer may be obtained at block 474 based on the over-drive period t_{od} obtained from the third lookup table, and the voltage may be sent to the tint driver at block 476. When the value of the target voltage (V_{target}) is 0, the tint driver may be turned off.

The voltage (V) and current (I) values applied/measured on the tint driver may be read from (or saved to) the lookup tables (e.g., the first lookup table, the transient I lookup table, the second lookup table, the third lookup table) at block 478. The blocks 472 to 478 may be repeated until the target transmittance setting is reached at block 460. At block 480, a fourth lookup table of historical data of the parameters (e.g., Vₚᵣₑᵥ, Iₚᵣₑᵥ, t_{od}, transmittance) with respect to time and temperature may be used to determine (e.g., interpolation) the transmittance T and chromaticity (u,v) used at block 464 based on the temperature of the light-transmissive controllable tint layer and the real time voltage (V) and current (I) applied to the light-transmissive controllable tint layer at block 476. Moreover, at block 480, the dynamic model described previously may be used to predict the transmittance more accurately by using the temperature of the light-transmissive controllable tint layer and the real time voltage (V) and current (I) applied to the light-transmissive controllable tint layer at block 476. The dynamic model may provide values of the transmittance for any values of the electrical inputs (e.g., voltage, current) applied to the light-transmissive controllable tint layer at the temperature of the light-transmissive controllable tint layer.

In addition, a machine learning process (e.g., a deep neural network (DNN), a recurrent neural network (RNN)) may be used to predict the transmittance of the light-transmissive controllable tint layer using data trained by historical data (e.g., measured data) at block 480, which may be used to generate real-time tint compensation for the images (e.g., the AR image content 208) displayed on the display 12. The results of the block 480 may be used to update the transmittance T and chromaticity (u,v) at block 464. For example, a DNN may be used to predict the optical properties (e.g., light absorption, light transmission, light reflection) of the light-transmissive controllable tint layer. The DNN may include an input layer, which may include the input parameters, such as temperature, V_{target}, historical data (e.g., Vₚᵣₑᵥ), aging of the EC materials 130, etc. The DNN may include multiple layers, such as a first layer, a second layer, a third layer, etc. Each layer may use input parameters and weights for the input parameters to improve the accuracy of the corresponding output, which may be input to the next layer for further process. The DNN may output final results (e.g., transmittance T, parameter X, parameter Y, parameter Z) at an output layer. In another example, an RNN block may be used for predicting the optical properties (e.g., light absorption, light transmission, light reflection) of the light-transmissive controllable tint layer. Multiple RNN blocks may be applied to historical data (e.g., measured data) to predict the optical properties (e.g., light absorption, light transmission, light reflection) of the light-transmissive controllable tint layer. RNN may memorize previous data and output from previous step may be fed as input to the current step, which may create a feedback loop. For instance, the RNN block may include memory from a previous block, an output of the previous block, an input vector, memory from the current block, and an output of the current block. The RNN block may include multiple computing components for calculations such as sigmoid, hyperbolic tangent, element-wise multiplication, and element-wise summation/concatenation. The RNN block may input multiple biases with the output of the previous block and the input vector to the computing components to calculate the output of the current block. The RNN block may be used for the lookup-table-based state estimation and the dynamic model described previously to predict the transmittance.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic device comprising:
a display panel implemented on a light-transmissive viewing surface of the electronic device, wherein the display panel is configured to display augmented reality image content overlaid on background image content viewed through the light-transmissive viewing surface;
a light-transmissive tint layer implemented on the light-transmissive viewing surface, wherein the background image content is viewed through the light-transmissive tint layer;
a tint driver configured to apply an electrical input to the light-transmissive tint layer during a time period, wherein the electrical input causes a change of a parameter of the light-transmissive tint layer; and
image processing circuitry communicatively coupled to the display panel, wherein the image processing circuitry is configured to generate compensated image data for the augmented reality image content based on the change of the parameter and image data of the augmented reality image content.

2. The electronic device of claim 1, wherein the light-transmissive tint layer comprises electro-chemical materials.

3. The electronic device of claim 2, wherein the electro-chemical materials comprise an anodic specie and a cathodic specie.

4. The electronic device of claim 1, wherein the electrical input comprises a voltage.

5. The electronic device of claim 4, wherein the voltage comprises a first voltage during a first time period of the time period and a second voltage during a second time period of the time period.

6. The electronic device of claim 5, wherein the first voltage is greater than the second voltage.

7. The electronic device of claim 1, wherein the parameter comprises a transmittance of the light-transmissive tint layer, or a chromaticity of the light-transmissive tint layer, or both.

8. The electronic device of claim 1, wherein the change of the parameter is associated with a temperature of the light-transmissive tint layer inferred from an electrical current applied to the light-transmissive tint layer.

9. The electronic device of claim 8, wherein the tint driver is configured to apply the electrical current to the light-transmissive tint layer during a steady state of the light-transmissive tint layer with a non-zero voltage applied to the light-transmissive tint layer.

10. The electronic device of claim 8, wherein the tint driver is configured to apply the electrical current to the light-transmissive tint layer during a transient state of the light-transmissive tint layer with an over-drive voltage applied to the light-transmissive tint layer.

11. The electronic device of claim 1, wherein the compensated image data is generated by modifying gray levels of color components of the image data of the augmented reality image content based on the change of the parameter of the light-transmissive tint layer.

12. An electronic display, comprising:
a display panel implemented on a light-transmissive viewing surface of the electronic display, wherein the display panel is configured to display augmented reality image content overlaid on background image content viewed through the light-transmissive viewing surface;
a light-transmissive tint layer implemented on the light-transmissive viewing surface, wherein the background image content is viewed through the light-transmissive tint layer;
a tint driver configured to:
predict a change of a parameter of the light-transmissive tint layer based on an electrical input applied to the light-transmissive tint layer, wherein the electrical input causes the change of the parameter; and
send the change of the parameter to image processing circuitry communicatively coupled to the display panel, wherein the image processing circuitry is configured to generate compensated image data for the augmented reality image content based on the change of the parameter and image data of the augmented reality image content.

13. The electronic display of claim 12, wherein the light-transmissive tint layer comprises electro-chemical materials.

14. The electronic display of claim 12, wherein the parameter comprises a transmittance of the light-transmissive tint layer, or a chromaticity of the light-transmissive tint layer, or both.

15. The electronic display of claim 12, wherein the change of the parameter is associated with a temperature of the light-transmissive tint layer inferred from an electrical current applied to the light-transmissive tint layer.

16. The electronic display of claim 15, wherein the tint driver is configured to apply the electrical current to the light-transmissive tint layer during a steady state of the light-transmissive tint layer with a non-zero voltage applied to the light-transmissive tint layer.

17. The electronic display of claim 15, wherein the tint driver is configured to apply the electrical current to the light-transmissive tint layer during a transient state of the light-transmissive tint layer with an over-drive voltage applied to the light-transmissive tint layer.

18. The electronic display of claim 12, wherein the tint driver configured to predict the change of the parameter based on historical data indicative of a relationship between the electrical input and the parameter.

19. The electronic display of claim 18, wherein the relationship is determined by using a polynomial and a sigmoid fitting of the historical data.

20. The electronic display of claim 12, wherein the tint driver configured to predict the change of the parameter based on a relationship between the electrical input and the parameter, wherein the relationship is obtained by determining an absorbance of the light-transmissive tint layer with respect to the electrical input.

21. The electronic display of claim 12, wherein the tint driver configured to predict the change of the parameter by using a machine learning process.

22. The electronic display of claim 21, wherein the machine learning process comprises a deep neural network, or a recurrent neural network, or both.

23. Electronic display circuitry comprising:
a temperature sensing circuit to determine a temperature of a light-transmissive tint layer implemented on a light-transmissive viewing surface based on an electrical current applied to the light-transmissive tint layer, wherein a display panel is implemented on the light-transmissive viewing surface and configured to display augmented reality image content overlaid on background image content viewed through the light-transmissive viewing surface;
an ambient light sensing circuit to determine a target transmittance of the light-transmissive tint layer
a tint control circuit configured to apply an electrical input to the light-transmissive tint layer based at least in part on the temperature and the target transmittance, wherein the electrical input causes a change of a parameter of the light-transmissive tint layer; and
image processing circuitry communicatively coupled to the display panel, wherein the image processing circuitry is configured to generate compensated image data for the augmented reality image content based on the change of the parameter and image data of the augmented reality image content.

24. The electronic display circuitry of claim 23, wherein the light-transmissive tint layer comprises electro-chemical materials.

25. The electronic display circuitry of claim 23, wherein the electrical current is applied to the light-transmissive tint layer during a steady state of the light-transmissive tint layer with a non-zero voltage applied to the light-transmissive tint layer.

26. The electronic display circuitry of claim 23, wherein the electrical current is applied to the light-transmissive tint layer during a transient state of the light-transmissive tint layer with an over-drive voltage applied to the light-transmissive tint layer.
